(19) United States
(12) Patent Application Publication
(10) Pub. No.: US 2014/0368625 A1
(43) Pub. Date: Dec. 18, 2014

(54) 3D IMAGE DISPLAY DEVICE AND METHOD THEREOF

(71) Applicant: National Taiwan University, Taipei (TW)

(72) Inventor: Ching-Fuh Lin, Taipei (TW)

(73) Assignee: National Taiwan University, Taipei (TW)

(21) Appl. No.: 14/284,837

(22) Filed: May 22, 2014

(30) Foreign Application Priority Data
Jun. 14, 2013 (TW) 102121062

(51) Int. Cl. H04N 13/04

(52) U.S. Cl. CPC H04N 13/0422
USPC 348/60

(57) ABSTRACT

A three-dimensional (3D) image display device and a method thereof are provided. A first light filtering unit obtains a first RGB color light filtered from a first image, and a second light filtering unit obtains a second RGB color light filtered from a second image, to produce a left-eye image and a right-eye image, respectively, or an active light emitting panel produces a first image and a second image of different wavelengths. When a user is wearing glasses with different light filters on the left and right lenses to filter out the right-eye image and the left-eye image, respectively, the user receives 3D visual effects from the images.

### BACKGROUND OF THE INVENTION

1. Field of the Invention

The present invention relates to three-dimensional (3D) image display techniques, and, more particularly, to a 3D image display device and a method thereof.

2. Description of Related Art

In recent years, as the quality of life improves, the trend of display technology has been moving from flat panel display technology to three-dimensional (3D) image display technology. Since the distance between the right eye and the left eye of a human being is about 6.5 cm, the viewing angles are slightly different when looking at an object and the received images will have slight differences. The so-called 3D image display technology utilizes the visual difference between the two eyes to provide two different images to produce a three-dimensional sense.

Most of the current 3D image display technologies require users to wear polarized glasses in order to create a three-dimensional effect from images generated by the 3D image displays. Polarized glasses worn by the left and right eyes employ horizontal and vertical polarized lenses, respectively, such that one of the eyes corresponding to the horizontal polarized lenses sees a horizontal image, and the other eye corresponding to the vertical polarized lens sees a vertical image, thereby generating a three-dimensional effect.

Currently available 3D displays can be generally divided into double-panel displays and single-panel displays. Double-panel displays uses two display panels each showing the image of one of the left and right eyes to achieve a 3D image display effect; the cost of which is higher. Single-panel display technology displays the images of the left and right eyes with the pixels of the panel in an interleaved fashion, in other words, the images for the left and right eyes are simultaneously shown on the same display; its 3D resolution is only half the native resolution of the panel.

In addition, both single and double-panel displays require users to wear polarized glasses to produce a three-dimensional image. However, the disadvantage of the polarized glasses is that when the head tilts or rotates, the polarized glasses cannot complete filter out the light in the other direction, so the eyes will see lights that are not completely filtered, resulting in images overlap and causing discomfort in users.

In addition to polarized glasses, another type of 3D glasses is active glasses, which are generally applied to displays with higher powers. However, active glasses themselves require the use of electricity, making active glasses heavier, and the manufacturing cost relatively higher.

Therefore, how to reduce the manufacturing costs of traditional 3D image displays and improve the shortcomings of polarized glasses has become an issue to be solved by one with ordinary skills in the art.

### SUMMARY OF THE INVENTION

In light of the foregoing drawbacks, the present invention provides a three-dimensional (3D) image display device, comprising: a light source module including a first backlight source for producing a first image light source and a second backlight source for producing a second image light source; a first light filtering unit incorporated with the first backlight source for filtering the first image light source to obtain a first RGB color light; a second light filtering unit incorporated with the second backlight source for filtering the second image light source to obtain a second RGB color light that has a second wavelength different from a first wavelength of the first RGB color light; a liquid crystal display module for time-interleaving the filtered first image light source and the filtered second image light source to produce a left-eye image and a right-eye image; a left lens having a third light filtering unit filtering the right-eye image; and a right lens having a fourth light filtering unit for filtering the left-eye image.

The present invention provides a three-dimensional (3D) image display method, comprising: providing a display device including a liquid crystal display module, a first backlight source that produces a first image light source, a second backlight source that produces a second image light source, a first light filtering unit incorporated with the first backlight source that filters the first image light source to obtain a first RGB color light, and a second light filtering unit incorporated with the second backlight source that filters the second backlight source to obtain a second RGB color light that has a second wavelength different from a first wavelength of the first RGB color light; time-interleaving, by using the liquid crystal display module, the filtered first image light source and the filtered second image light source to produce a left-eye image and a right-eye image; filtering the right-eye image by using a left lens having a third light filtering unit; and filtering the left-eye image by using a right lens having a fourth light filtering unit.

The present invention further provides a three-dimensional (3D) image display device, comprising: a light source module for producing an image light source; a liquid crystal display module for producing an image from the image light source, the liquid crystal display module being provided with a first light filtering unit that filters a first RGB color light to allow the light crystal display module to produce a left-eye image, and a second light filtering unit that filters a second RGB color light to allow the liquid crystal display module to produce a right-eye image, the first RGB color light having a first wavelength different from a second wavelength of the second RGB color light; a left lens having a third light filtering unit that filters the right-eye image; and a right lens having a fourth light filtering unit that filters the left-eye image.

In the above three-dimensional (3D) image display device, the light source module includes a first backlight source incorporated with the first light filtering unit for producing a first image light source and a second backlight source incorporated with the second light filtering unit for producing a second image light source, the image light source is composed of the first image light source and the second image light source. Moreover, the liquid crystal display module time-interleaving the filtered first image light source and the filtered second image light source to produce the left-eye image and the right-eye image, respectively.

The present invention further provides a three-dimensional (3D) image display method, comprising: providing a display device including a light source module and a liquid crystal display module to allow the liquid crystal display module to display an image from an image light source produced by the light source module; filtering a first RGB color light of the image light source, by using a first light filtering unit provided on the liquid crystal display module to produce a left-eye image; filtering a second RGB color light of the image light source by using a second light filtering unit provided on the liquid crystal display module to produce a right-eye image, the first RGB color light having a first wavelength different from a second wavelength of the second RGB color light; filtering the right-eye image by using a left lens having a third light filtering unit; and filtering the left-eye image by using a right lens having a fourth light filtering unit.

The present invention also provides a three-dimensional (3D) image display device, comprising: an active light emitting panel including a plurality of pixel modules, each of the pixel modules including a first light source for producing a first RGB color light and a second light source for producing a second RGB color light that has a second wavelength different from a first wavelength of the first RGB color light, the active light emitting panel producing a first image from the first light source and a second image from the second light source; a left lens having a first light filtering unit that filters the second image; and a right lens having a second light filtering unit that filters the first image.

The present invention also provides a three-dimensional (3D) image display method, comprising: providing an active light emitting panel including a plurality of pixel modules, each of the pixel modules including a first light source for producing a first RGB color light and a second light source for producing a second RGB color light, the active light emitting panel producing from the first light source a first image and from the second light source a second image having a second wavelength different wavelengths a first wavelength of the first image; providing a left lens having a first light filtering unit that filters the second image; and providing a right lens having a second light filtering unit that filters the first image.

The present invention also provides a three-dimensional (3D) image display device, comprising: an active light emitting panel including a first pixel module for producing a first light source of a first RGB color light and a second pixel module for producing a second light source of a second RGB color light and producing from the first pixel module a first image and from the second pixel module a second image having a second wavelength different from a first wavelength of the first image, the first pixel module and the second pixel module being alternately arranged on the active light emitting panel and producing the first image and the second image in a time-interleaving manner; and a pair of glasses that includes a left lens having a first light filtering unit that filters the second image, and a right lens having a second light filtering unit that filters the first image.

The present invention also provides a three-dimensional (3D) image display method, comprising: providing an active light emitting panel including a first pixel module for producing a first light source of a first RGB color light and a second pixel module for producing a second light source of a second RGB color light and producing from the first pixel module a first image and the second pixel module a second image that has a second wavelength different from a first wavelength of the first image, the first pixel module and the second pixel module being alternately arranged on the active light emitting panel and producing the first image and the second image in a time-interleaving manner; providing a left lens having a first light filtering unit that filters the second image; and providing a right lens having a second light filtering unit that filters the first image.

The present invention also provides a three-dimensional (3D) image display device, comprising: an active light emitting panel including a first light filtering unit that obtains a first RGB color light and a second light filtering unit alternately arranged with respect to the first light filtering unit that obtains a second RGB color light, and producing from the first light filtering unit a first image and from the second light filtering unit a second image having a second wavelength different from a first wavelength of the first image; a left lens having a third light filtering unit that filters the second image; and a right lens having a fourth light filtering unit that filters the first image.

The present invention also provides a three-dimensional (3D) image display method, comprising: providing an active light emitting panel provided with a first light filtering unit that obtains a first RGB color light and a second light filtering unit alternately arranged with respect to the first light filtering unit that obtains a second RGB color light, and producing from the first light filtering unit a first image and from the second light filtering unit a second image having a second wavelength different from a first wavelength of the first image; providing a left lens having a third light filtering unit that filters the second image; and providing a right lens having a fourth light filtering unit that filters the first image.

According to the present invention, the display devices output the left-eye image and the right-eye image produced by the first RGB color light and the second RGB color light of different wavelength ranges, respectively, and the light filtering unit on the left lens of the glasses filters out the right-eye image and allows only the left-eye image to pass through, while the light filtering unit on the right lens of the glasses filters out the left-eye image and allows only the right-eye image to pass through. Thus, when a user wearing the glasses looks at a 3D image, it will not have the problem of image overlap due to tilting of the head in the case of polarized glasses. Moreover, since the glasses proposed by the present invention incorporate different light filters on the left and right lenses, it eliminates the issues of bulkiness and high cost as in the case of active glasses.

### BRIEF DESCRIPTION OF THE DRAWINGS

The present invention can be more fully understood by reading the following detailed description of the preferred embodiments, with reference made to the accompanying drawings, wherein:

FIG. 1A is a first embodiment of a 3D image display device in accordance with the present invention;

FIG. 1B is a flowchart illustrating the 3D image display method in accordance with the first embodiment of the present invention;

FIG. 2A is a second embodiment of a 3D image display device in accordance with the present invention;

FIG. 2B is a diagram depicting a distribution of first light filtering units and second light filtering units of the second embodiment;

FIG. 2C is a flowchart illustrating the 3D image display method in accordance with the second embodiment of the present invention;

FIG. 3A is a third embodiment of a 3D image display device in accordance with the present invention;

FIG. 3B is a diagram depicting a distribution of a first light source and a second light source of the third embodiment;

FIG. 3C is a flowchart illustrating the 3D image display method in accordance with the third embodiment of the present invention;

FIG. 4A is a fourth embodiment of a 3D image display device in accordance with the present invention;

FIG. 4B is a diagram depicting a distribution of pixel modules of the fourth embodiment;

FIG. 4C is a flowchart illustrating the 3D image display method in accordance with the fourth embodiment of the present invention;

FIG. 5A is a fifth embodiment of a 3D image display device in accordance with the present invention;

FIG. 5B is a diagram depicting a distribution of first light filtering units and second light filtering units of the fifth embodiment; and

FIG. 5C is a flowchart illustrating the 3D image display method in accordance with the fifth embodiment of the present invention.

### DETAILED DESCRIPTION OF THE EMBODIMENTS

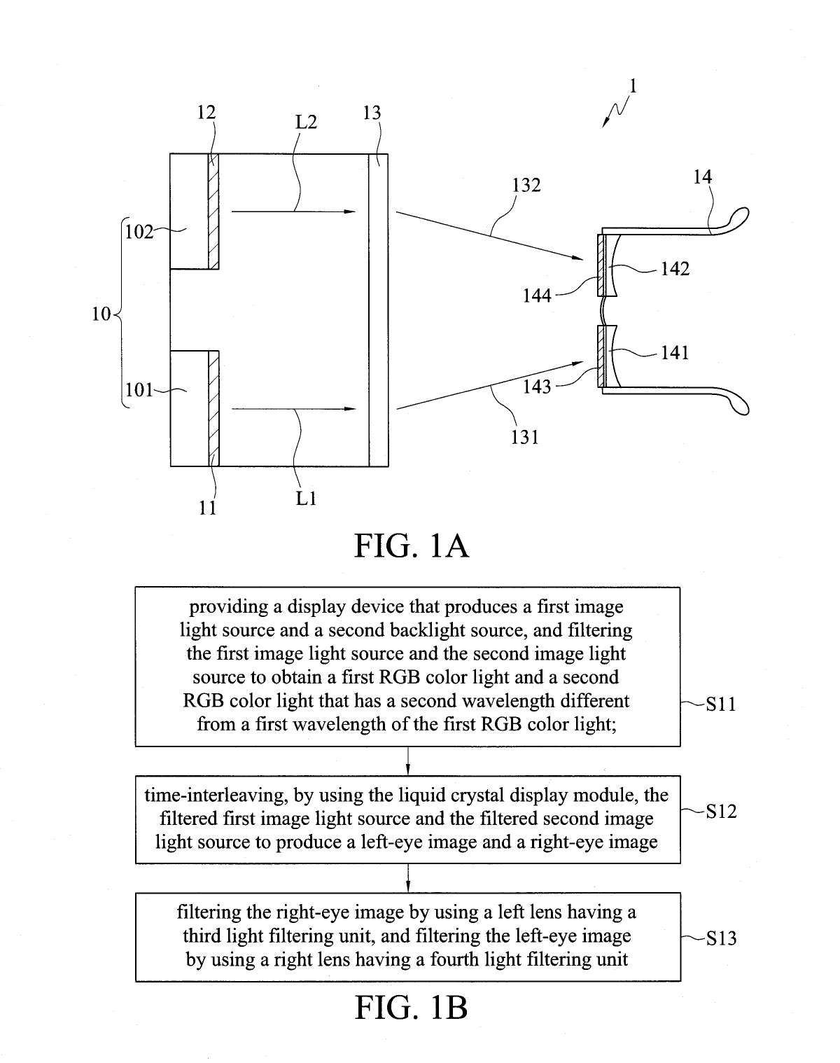

Referring to FIG. 1A, a first embodiment of a three-dimensional (3D) image display device 1 in accordance with the present invention is shown. The 3D image display device 1 includes a light source module 10, a first light filtering unit 11, a second light filtering unit 12, a liquid crystal display module 13, and a pair of glasses 14.

The light source module 10 has a first backlight source 101 and a second backlight source 102. The first backlight source 101 generates and outputs a first image light source L1. The second backlight source 102 generates and outputs a second image light source L2. Since the wavelength range of the first image light source L1 generated by the first backlight source 101 is the same as that of the second image light source L2 generated by the second backlight source 102, the first backlight source 101 of the light source module 10 incorporates the first light filtering unit 11, while the second backlight source 102 incorporates the second light filtering unit 12. The first light filtering unit 11 filters the first image light source L1 generated by the first backlight source 101 to obtain a first RGB color light (of a specific wavelength range). The second light filtering unit 12 filters the second image light source L2 generated by the second backlight source 102 to obtain a second RGB color light (of another specific wavelength range). The wavelengths of the filtered first RGB color light are different from those of the filtered second RGB color light. With the filtered first image light source L1 and the second image light source L2, the liquid crystal display module 13 generates a left-eye image 131 and a right-eye image 132, respectively.

The liquid crystal display module 13 alternates the left-eye image 131 and the right-eye image 132 in time. More specifically, the liquid crystal display module 13 outputs the left-eye image 131 and the right-eye image 132 at different points in time. For example, the left-eye image 131 is outputted at the first second, and the right-eye image 132 is outputted at the next second.

When a user is looking at the left-eye image 131 and the right-eye image 132 generated by the liquid crystal display module 13, in order for the left-eye image 131 and the right-eye image 132 to create 3D effects for the user, the user has to wear the glasses 14 for creating 3D effects while looking at the liquid crystal display module 13. The glasses 14 have a left lens 141 corresponding to the left eye of the user and a right lens 142 corresponding to the right eye of the user. The left lens 141 includes a third light filtering unit 143 for filtering out the right-eye image 132, and the right lens 142 includes a fourth light filtering unit 144 for filtering out the left-eye image 131. Once the user wears the glasses 14 with the third light filtering unit 143 and the fourth light filtering unit 144, the left eye of the user receives only the left-eye image 131 since the third light filtering unit 143 filters out the right-eye image 132, and the right eye of the users receives only the right-eye image 132 since the fourth light filtering unit 144 filters out the left-eye image 131, thereby creating 3D effects in the eyes of the user.

Referring now to FIG. 1B, a flowchart illustrating the 3D image display method in accordance with the first embodiment of the present invention is shown. In step S11, a display device having a first backlight source, a second backlight source and a liquid crystal display module is provided. The first backlight source and the second backlight source generate a first image light source and a second image light source, respectively. A first light filtering unit incorporated with the first backlight source filters the first image light source to obtain a first RGB color light. A second light filtering unit incorporated with the second backlight source filters the second image light source to obtain a second RGB color light that has a second wavelength different from a first wavelength of the first RGB color light. In step S12, the liquid crystal display module generates a left-eye image and a right-eye image with the filtered first image light source and the filtered second image light source, respectively, in a time-interleaving manner. In step S13, a pair of glasses is provided. The glasses include a left lens having a third light filtering unit and a right lens with a fourth light filtering unit. The third light filtering unit filters out the right-eye image. The fourth light filtering unit filters out the left-eye image. When a user wears the glasses and looks at the display device, a 3D image is created from the left-eye image and the right-eye image received by the left and right eyes.

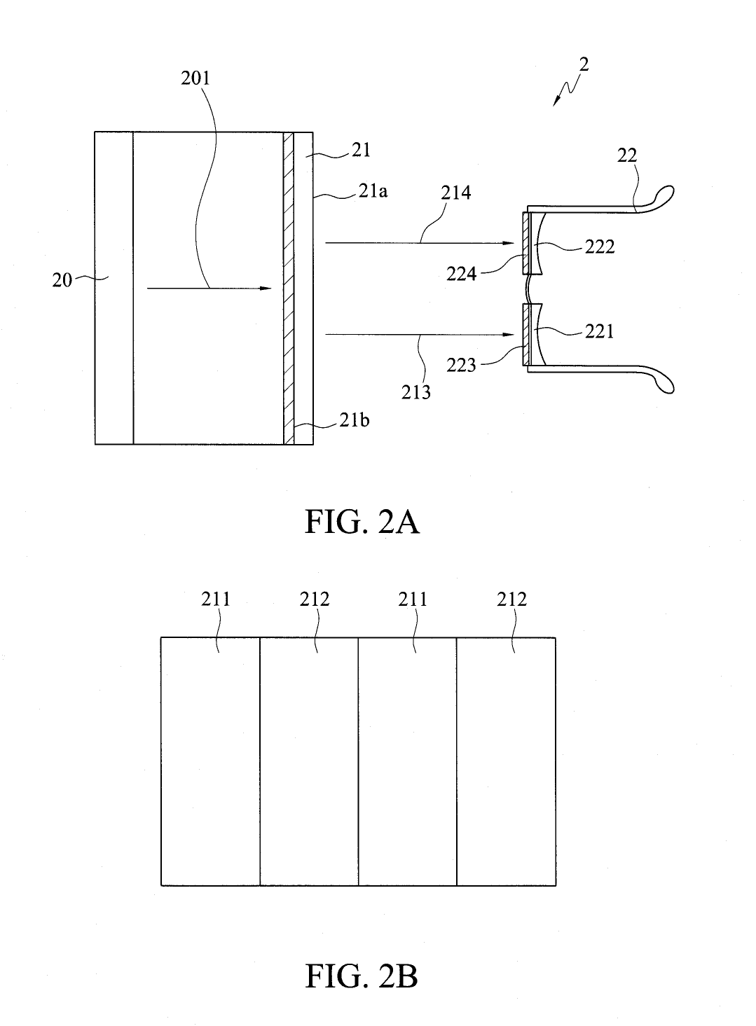

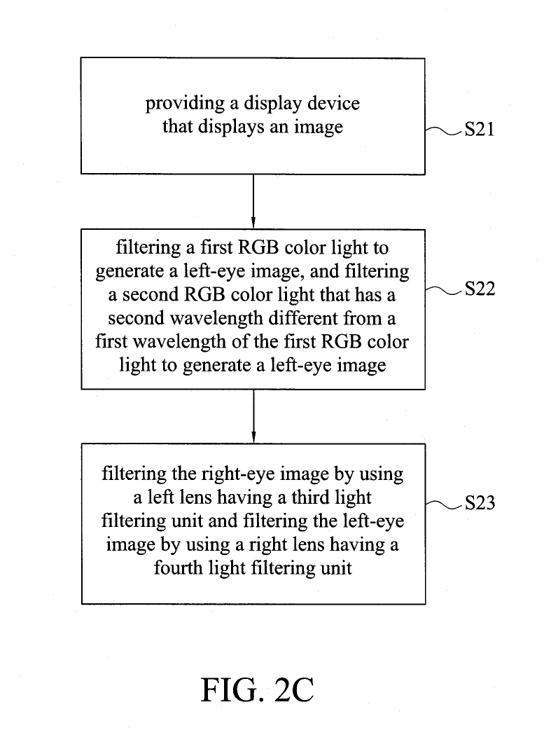

Referring now to both FIGS. 2A and 2B, a second embodiment of a 3D image display device 2 in accordance with the present invention is shown in FIG. 2A, and a distribution of first light filtering units and second light filtering units is shown in FIG. 2B. The 3D image display device 2 includes a light source module 20, a liquid crystal display module 21 and a pair of glasses 22.

The light source module 20 generates an image light source 201. The liquid crystal display module 21 generates an image by using the image light source 201. The liquid crystal display module 21 is provided with first light filtering units 211 and second light filtering units 212. The first light filtering units 211 are used for filtering the image light source 201 to obtain a first RGB color light, so that the liquid crystal display module 21 correspondingly produces a left-eye image 213. The second light filtering units 212 are used for filtering the image light source 201 to obtain of a second RGB color light, so that the liquid crystal display module 21 correspondingly produces a right-eye image 214. The first RGB color light filtered by the first light filtering units 211 has a first wavelength different from a second wavelength of the second RGB color light filtered by the second light filtering units 212.

The liquid crystal display module 21 has a first surface 21a and a second surface 21b. The first light filtering units 211 and the second light filtering units 212 can be provided on the first surface 21a and the second surface 21b of the liquid crystal display module 21. However, the first light filtering units 211 and the second light filtering units 212 both have to be provided on the first surface 21a or the second surface 21b at the same time.

It can be seen from FIG. 2B that the first light filtering units 211 and the second light filtering units 212 are simultaneously provided on the liquid crystal display module 21 in an interleaving manner. The first light filtering units 211 and the second light filtering units 212 can be provided on the liquid crystal display module 21 in a way such that the first light filtering units 211 and the second light filtering units 212 are alternately provided by being directly coated on the liquid crystal display module 21, or a light filter (not shown) is first formed from interleaving first light filtering units 211 and second light filtering units 212 and then the light filter 23 is adhered onto the liquid crystal display module 21.

When a user is looking at the left-eye image 213 and the right-eye image 214 generated by the liquid crystal display module 21, in order for the left-eye image 213 and the right-eye image 214 to create 3D effects for the user, the user must wear the glasses 22 for creating 3D effects. The glasses 22 have a left lens 221 corresponding to the left eye of the user and a right lens 222 corresponding to the right eye of the user. The left lens 221 includes a third light filtering unit 223 for filtering out the right-eye image 214. The right lens 222 includes a fourth light filtering unit 224 for filtering out the left-eye image 213. Once the user wears the glasses 22 with the third light filtering unit 223 and the fourth light filtering unit 224, the left eye of the user receives only the left-eye image 213 since the third light filtering unit 223 filters out the right-eye image 214, and the right eye of the users receives only the right-eye image 214 since the fourth light filtering unit 224 filters out the left-eye image 213, thereby creating 3D effects in the eyes of the user.

Referring now to FIG. 2C, a flowchart illustrating the 3D image display method in accordance with the second embodiment of the present invention is shown. In step S21, a display device having a light source module and a liquid crystal display module is provided. The liquid crystal display module displays an image using the image light source produced by the light source module. In step S22, the image light source is filtered by the first light filtering units and the second light filtering units to obtain a first RGB color light and a second RGB color light, respectively, so as to produce a left-eye image and a right-eye image, respectively. The wavelengths of the first RGB color light and the wavelengths of the second RGB color light are different. In step 23, a pair of glasses is provided which includes a left lens having a third light filtering unit and a right lens with a fourth light filtering unit. The third light filtering unit filters out the right-eye image. The fourth light filtering unit filters out the left-eye image. When a user wears the glasses and looks at the display device, a 3D image is created from the left-eye image and the right-eye image received by the left and right eyes.

The first light filtering units and the second light filtering units are alternately arranged on an inner surface or an outer surface of the liquid crystal display module, or a light filter is first formed from interleaving first light filtering units and second light filtering units and then the light filter is adhered onto an inner surface or an outer surface of the liquid crystal display module.

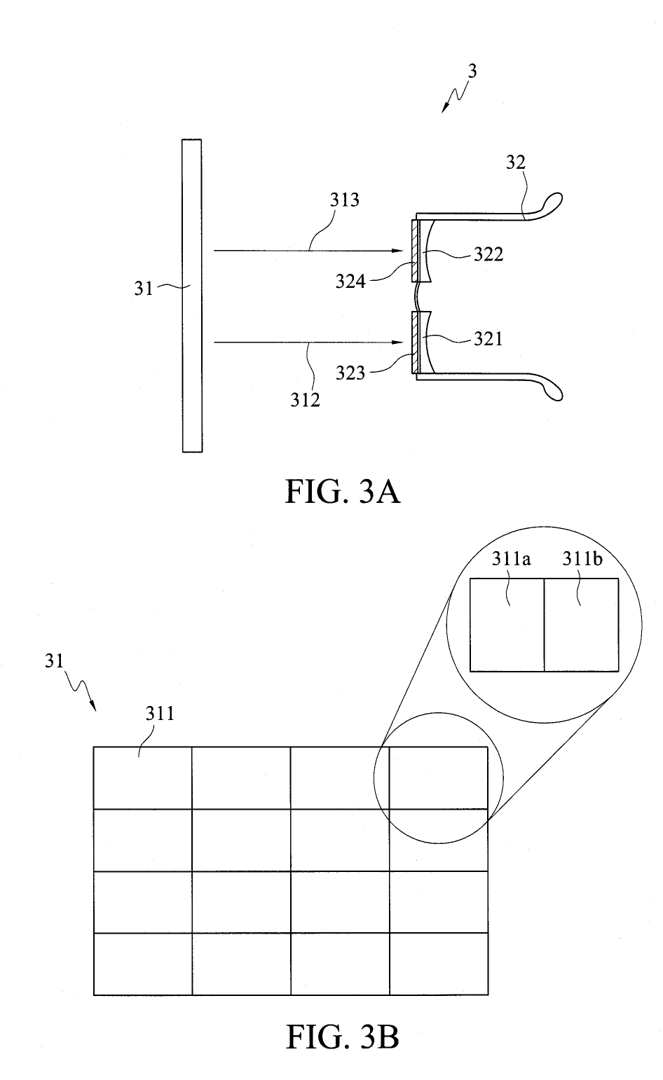

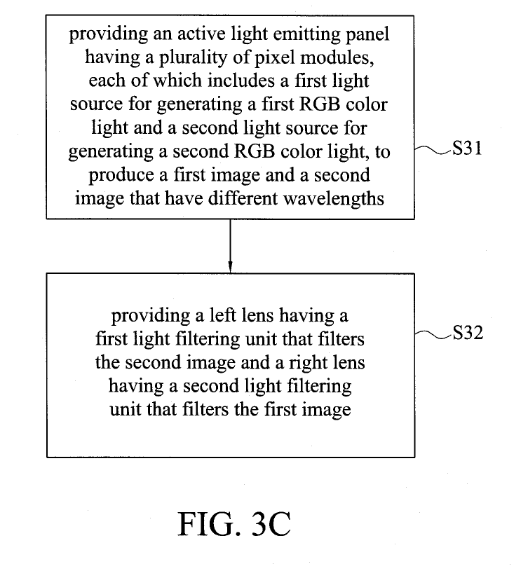

Referring now to both FIGS. 3A and 3B, a third embodiment of a 3D image display device 3 in accordance with the present invention is shown in FIG. 3A, and a distribution of a first light source and a second light source is shown in FIG. 3B. The 3D image display device 3 includes an active light emitting panel 31 and a pair of glasses 32. The active light emitting panel 31 is used for displaying images. The glasses 32 are used for receiving the images.

As shown in FIG. 3B, the active light emitting panel 31 has a plurality of pixel modules 311. Each of the pixel modules 311 includes a first light source 311a and a second light source 311b. The first light source 311a is used for generating a first RGB color light, and the second light source 311b is used for generating a second RGB color light. The active light emitting panel 31 produces from the first RGB color light of the first light sources 311a a first image 312 corresponding to the left eye of a user, and from the second RGB color light of the second light sources 311b a second image 313 corresponding to the right eye of the user. The first RGB color light and the second RGB color light have different wavelengths, and the first image 312 and the second image 313 produced by the active light emitting panel 31 are different from each other.

When the user is looking at the active light emitting panel 31, in order for the first image 312 and second image 313 of the active light emitting panel 31 to create 3D effects for the user, the user must wear the glasses 32 for creating 3D effects. The glasses 32 have a left lens 321 corresponding to the left eye of the user and a right lens 322 corresponding to the right eye of the user. The left lens 321 includes a first light filtering unit 323 for filtering out the second image 313, and the right lens 322 includes a second light filtering unit 324 for filtering out the first image 312. Once the user wears the glasses 32 with the first light filtering unit 323 and the second light filtering unit 324, the left eye of the user receives only the first image 312 since the first light filtering unit 323 on the left lens 321 filters out the second image 313 of the active light emitting panel 31, and the right eye of the users receives only the second image 313 since the second light filtering unit 324 on the right lens 322 filters out the first image 312 of the active light emitting panel 31, thereby creating images with 3D effects in the eyes of the user.

Referring now to FIG. 3C, a flowchart illustrating the 3D image display method in accordance with the third embodiment of the present invention is shown. In step S31, an active light emitting panel with a plurality of pixel modules is provided, each of which includes a first light source and a second light source. The active light emitting panel produces a first image and a second image with different wavelengths from the first light sources and the second light sources, respectively. In step S32, a left lens having a first light filtering unit and a right lens with a second light filtering unit are provided. The first light filtering unit filters out the second image, and the second light filtering unit filters out the first image, such that a user receives 3D images through the left lens and the right lens.

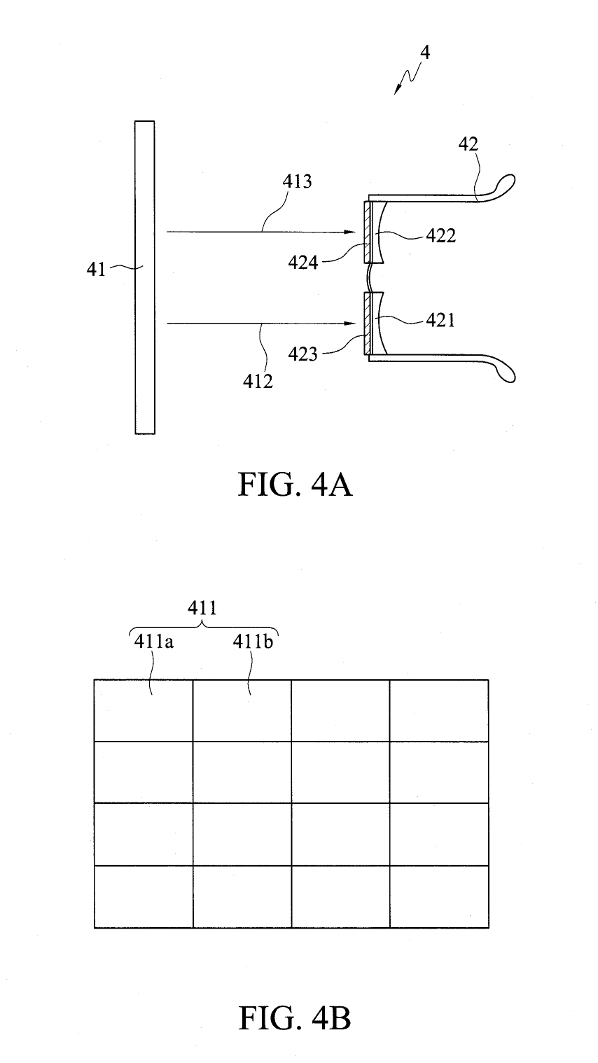

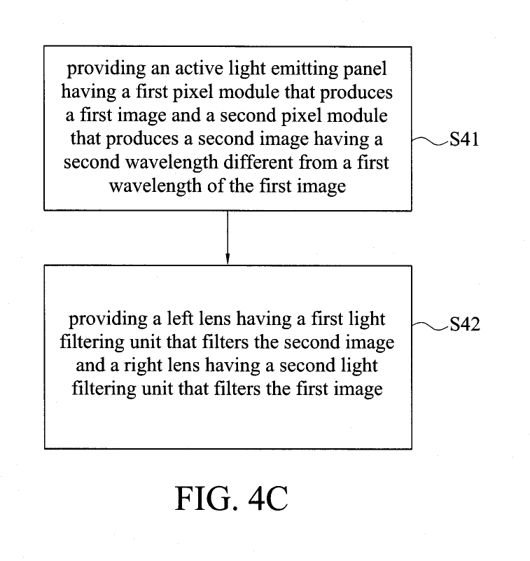

Referring now to both FIGS. 4A and 4B, a fourth embodiment of a 3D image display device 4 in accordance with the present invention is shown in FIG. 4A, and a distribution of pixel modules is shown in FIG. 4B. As shown, the 3D image display device 4 includes an active light emitting panel 41 and a pair of glasses 42.

The active light emitting panel 41 has a plurality of pixel modules 411. The pixel modules 411 include alternative arranged first pixel modules 411a and second pixel modules 411b. As shown in FIG. 4B, the first pixel modules 411a are used for generating a first RGB color light, and the second pixel modules 411b are used for generating a second RGB color light. The active light emitting panel 41 produces from the first RGB color light a first image 412 corresponding to the left eye of a user, and from the second RGB color light of the second pixel modules 411b a second image 413 corresponding to the right eye of the user. The first RGB color light and the second RGB color light have different wavelengths, and the first image 412 and the second image 413 produced by the active light emitting panel 41 are different from each other.

The first pixel modules 411a and the second pixel modules 411b display the first RGB color light and the second RGB color light in a time-interleaving manner, and the first pixel modules 411a and the second pixel modules 411b output the first RGB color light and the second RGB color light, respectively, at different points in time.

When the user is looking at the active light emitting panel 41, in order for the first image 412 and second image 413 of the active light emitting panel 41 to create 3D effects for the user, the user must wear the glasses 42 for creating 3D effects. The glasses 42 have a left lens 421 corresponding to the left eye of the user and a right lens 422 corresponding to the right eye of the user. The left lens 421 includes a first light filtering unit 423 for filtering out the second image 413, and the right lens 422 includes a second light filtering unit 424 for filtering out the first image 412. Once the user wears the glasses 42 with the first light filtering unit 423 and the second light filtering unit 424, the left eye of the user receives only the first image 412 since the first light filtering unit 423 on the left lens 421 filters out the second image 413 of the active light emitting panel 41, and the right eye of the users receives only the second image 413 since the second light filtering unit 424 on the right lens 422 filters out the first image 412 of the active light emitting panel 41, thereby creating images with 3D effects in the eyes of the user.

Referring now to FIG. 4C, a flowchart illustrating the 3D image display method in accordance with the fourth embodiment of the present invention is shown. In step S41, an active light emitting panel with a plurality of pixel modules is provided. The pixel modules include first pixel modules for producing a first RGB color light and second pixel modules for producing a second RGB color light. The active light emitting panel produces from the first pixel modules a first image and the second pixel modules a second image has a second wavelength different from a first wavelength of the first image. The first pixel modules and the second pixel modules are alternately arranged on the active light emitting panel, and the first pixel modules and the second pixel modules display the first RGB color light and the second RGB color light in a time-interleaving manner. In step S42, a left lens having a first light filtering unit and a right lens with a second light filtering unit are provided. The first light filtering unit filters out the second image, and the second light filtering unit filters out the first image, such that a user receives 3D images through the left lens and the right lens.

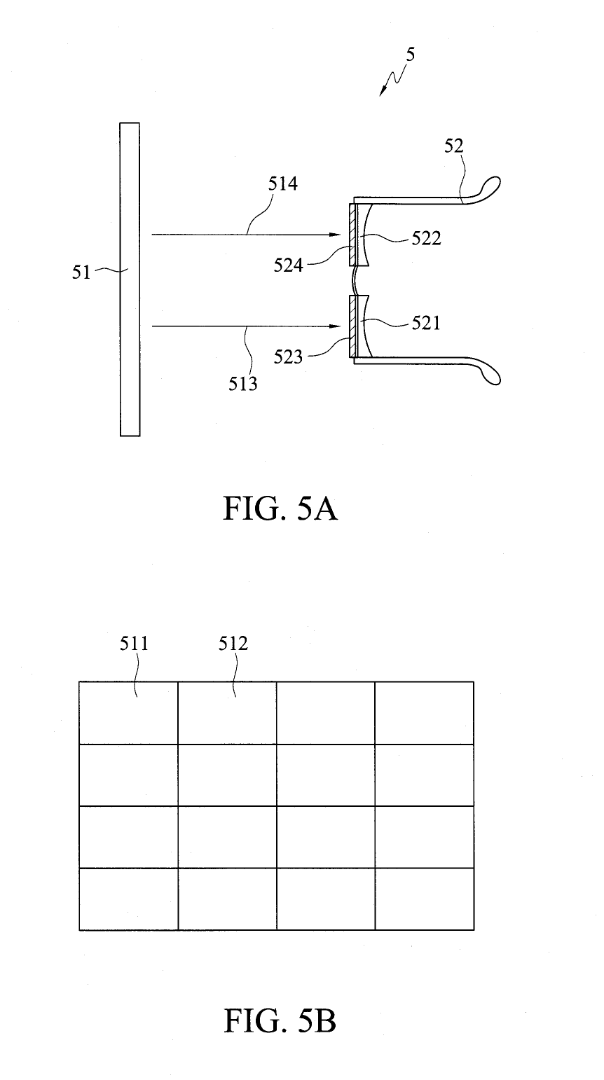

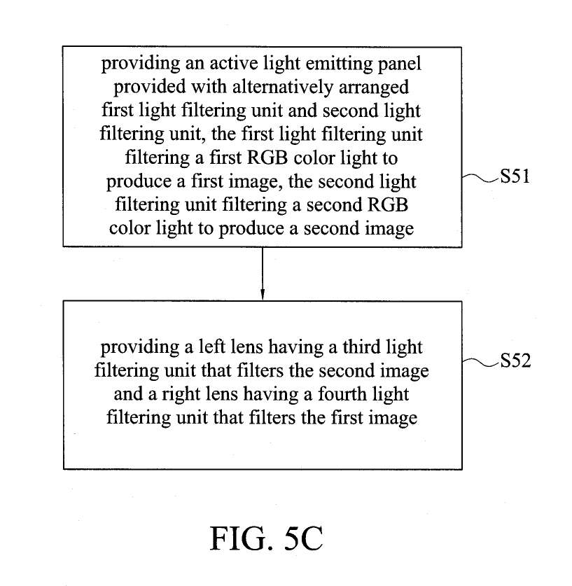

Referring now to both FIGS. 5A and 5B, a fifth embodiment of a 3D image display device 5 in accordance with the present invention is shown in FIG. 5A, and a distribution of first light filtering units and second light filtering units is shown in FIG. 5B. The 3D image display device 5 includes an active light emitting panel 51 and a pair of glasses 52.

In FIG. 5B, the active light emitting panel 51 includes alternatively arranged first light filtering units 511 and second light filtering units 512. The first light filtering units 511 are used for obtaining a first RGB color light, the second light filtering units 512 are used for obtaining a second RGB color light, and the first RGB color light and the second RGB color light have different wavelengths. The active light emitting panel 51 produces a first image 513 corresponding to the left eye of a user by using the first light filtering units 511, and a second image 514 corresponding to the right eye of the user by using the second light filtering units 512.

In FIG. 5B, the first light filtering units 511 and the second light filtering units 512 are alternately arranged on the active light emitting panel 51. The first light filtering units 511 and the second light filtering units 512 can be directly coated onto the active light emitting panel 51, or a light filter is first formed by alternately providing the first light filtering units 511 and the second light filtering units 512 and then the light filter is adhered onto the active light emitting panel 51.

When the user is looking at the active light emitting panel 51, in order for the first image 513 and second image 514 of the active light emitting panel 51 to create 3D effects for the user, the user must wear the glasses 52 for creating 3D effects. The glasses 52 have a left lens 521 corresponding to the left eye of the user and a right lens 522 corresponding to the right eye of the user. The left lens 521 includes a third light filtering unit 523 for filtering out the second image 514, and the right lens 522 includes a fourth light filtering unit 524 for filtering out the first image 513. Once the user wears the glasses 52 with the third light filtering unit 523 and the fourth light filtering unit 524, the left eye of the user receives only the first image 513 since the third light filtering unit 523 on the left lens 521 filters out the second image 514 of the active light emitting panel 51, and the right eye of the users receives only the second image 514 since the fourth light filtering unit 524 on the right lens 522 filters out the first image 513 of the active light emitting panel 51, thereby creating images with 3D effects in the eyes of the user.

Referring now to FIG. 5C, a flowchart illustrating the 3D image display method in accordance with the fifth embodiment of the present invention is shown. In step S51, an active light emitting panel with alternatively arranged first light filtering units and second light filtering units is provided. The first light filtering unit is used for obtaining a first RGB color light, and the second light filtering units are used for obtaining a second RGB color light. The active light emitting panel produces a first image and a second image with different wavelengths by the first light filtering units and the second light filtering units, respectively. In step S52, a left lens having a third light filtering unit and a right lens with a fourth light filtering unit are provided. The third light filtering unit filters out the second image, and the fourth light filtering unit filters out the first image, such that a user receives 3D images through the left lens and the right lens.

The above embodiments are only used to illustrate the principles of the present invention, and should not be construed as to limit the present invention in any way. The above embodiments can be modified by those with ordinary skill in the art without departing from the scope of the present invention as defined in the following appended claims.

What is claimed is:

1. A three-dimensional image display device, comprising:
a light source module for producing an image light source;
a liquid crystal display module for producing an image from the image light source, the liquid crystal display module being provided with a first light filtering unit that filters a first RGB color light to allow the light crystal display module to produce a left-eye image, and a second light filtering unit that filters a second RGB color light to allow the liquid crystal display module to produce a right-eye image, the first RGB color light having a first wavelength different from a second wavelength of the second RGB color light;
a left lens having a third light filtering unit that filters the right-eye image; and
a right lens having a fourth light filtering unit that filters the left-eye image.

2. The three-dimensional image display device of claim 1, wherein the light source module includes a first backlight source incorporated with the first light filtering unit for producing a first image light source and a second backlight source incorporated with the second light filtering unit for producing a second image light source, the image light source is composed of the first image light source and the second image light source.

3. The three-dimensional image display device of claim 2, wherein the liquid crystal display module time-interleaving the filtered first image light source and the filtered second image light source to produce the left-eye image and the right-eye image, respectively.

4. The three-dimensional image display device of claim 1, wherein the liquid crystal display module has a first surface facing a user and a second surface facing the light source module, and the first light filtering unit and the second light filtering unit are disposed on the first surface or on the second surface at the same time.

5. The three-dimensional image display device of claim 4, wherein the first light filtering unit and the second light filtering unit are alternately arranged on the first surface or on the second surface, or the first light filtering unit and the second light filtering unit are alternately provided to form a light filter that is provided on the first surface or on the second surface.

6. A three-dimensional image display device, comprising:
an active light emitting panel including a first pixel module for producing a first light source of a first RGB color light and a second pixel module for producing a second light source of a second RGB color light, and producing from the first pixel module a first image and from the second pixel module a second image having a second wavelength different from a first wavelength of the first image, the first pixel module and the second pixel module being alternately arranged on the active light emitting panel and producing the first image and the second image in a time-interleaving manner;
a left lens having a first light filtering unit that filters the second image; and
a right lens having a second light filtering unit that filters the first image.

7. A three-dimensional image display device, comprising:
an active light emitting panel including a first light filtering unit that obtains a first RGB color light and a second light filtering unit alternately arranged with respect to the first light filtering unit that obtains a second RGB color light, and producing from the first light filtering unit a first image and from the second light filtering unit a second image having a second wavelength different from a first wavelength of the first image;
a left lens having a third light filtering unit that filters the second image; and
a right lens having a fourth light filtering unit that filters the first image.

8. The three-dimensional image display device of claim 7, wherein the first light filtering unit and the second light filtering unit are alternately arranged on the active light emitting panel, or alternately arranged to form a light filter that is provided on the active light emitting panel.
